(19) United States
(12) Patent Application Publication
(10) Pub. No.: US 2008/0196601 A1
(43) Pub. Date: Aug. 21, 2008

(54) OIL EXPELLER

(76) Inventor: Jose Guilherme Scott, Sao Paulo (BR)

Correspondence Address: GOTTLIEB RACKMAN & REISMAN PC, 270 MADISON AVENUE, 8TH FLOOR, NEW YORK, NY, 10016-0601, US

(21) Appl. No.: 11/619,843

(22) Filed: Jan. 4, 2007

(30) Foreign Application Priority Data
Jan. 10, 2006 (BR) PI 0601253-1

(51) Int. Cl. A23N 1/00

(52) U.S. Cl. 99/495

(57) ABSTRACT

The present patent refers to the invention and further development of the oil expeller machine, especially edible and personal use oils, such as those extracted from fruits, grains, flowers and others, seeking to obtain the separation of the solids and the oils that efficiently make it.

The objective of the new expeller is to use an expelling tube that does not require assembly nor disassembly of its components, once it is made unique as a whole.

The other objective is to supply an oil expeller that is able to keep up the quality of the continuous oil expelling.

### RELATED APPLICATIONS

This application claims the priority date of Brazilian Patent Application number PI 0601253-1 filed Jan. 10, 2006.

### BACKGROUND OF THE INVENTION

The present Invention patent Concerns the enhancement of an oil expelling machine, specially edible, personal use oils, like those expelled from fruit, grains, flowers and others, intending the efficient separation of oils and solids.

This type of oil extraction is made through many ways, including mechanical and chemical processes.

The extraction processes that involve chemicals are not desired because of its components, however it has been widely used in larger installations due to its lower cost.

The mechanical processes used basically consist in pressing the fruit/grain/flower, among others, using devices, mostly archaic, as found in the process of extracting olive oil, in which conical coils are placed into a barrel over the olives, or through worm screwed presses that compresses the olives.

Extraction methods have been developed in which a worm screwed extrusion device loads the fruits/grains/flowers to be processed from a feeder and are conducted to a portion of the extrusion device where small veins allow the oil to flow out.

Currently these veins are defined by the space created by flat bars mounted in a mechanical structure that holds them in a cylindrical shape and that involves a portion of the mentioned worm screw.

Despite the fact that this system operates accordingly, it still presents setup and maintenance concerns every time cleaning or sharpening is required because the whole system must be manually disassembled and reassembled.

Also, because the way these bars are mounted, the veins between them can vary too much, therefore the quality of the oil expelled will not be ideal and may require a more intense filtration process.

The objective of this new expeller is to use an expelling tube that does not require assembling nor disassembling its components, once it is a unique engineered device by itself.

Another goal is to provide an oil expeller that keep up the quality and repeatability of the process.

This is reached because the tube shaped expelling system has openings that allow the expelled oil to pass out.

The length and width of these openings are designed to attend the material to be processed.

To further develop the knowledge and comprehension of the innovation the attached drawings were provided to better illustrate, being:

### BRIEF DESCRIPTION OF THE DRAWINGS

FIG. 1 shows a sectional view of an expeller machine with the new expelling system in place;

FIG. 2 shows a perspective view of an expelling system attending the current technical development state; and

FIG. 3 shows a perspective view of the new expelling system.

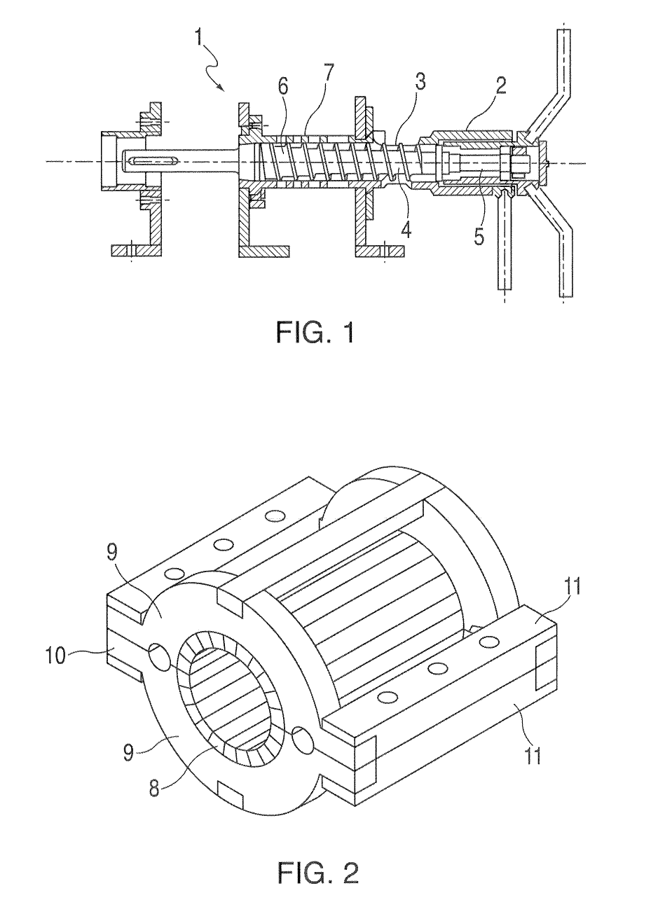

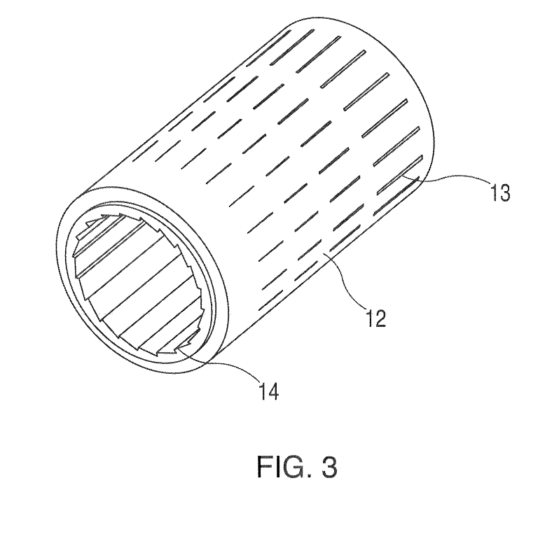

### DETAILED DESCRIPTION OF THE INVENTION

The expeller machine (1) is typically built with a body (2) provided with the feeder (3) connected to the worm screw (4). The axle is powered by a gearmotor (5) and the portion of the exit of the worm screw (6) is involved by the oil expeller.

The oil expeller built according to the current technical development state is formed typically by bars (8), mounted in a pair of bipartite rings (9) that possess saliencies (10) that allow its setting through connecting rods (11).

During the operation, the pressure of the material against the internal wall by the action of the expeller makes the oil to pass between the bars (8) to the exterior, maintaining the remaining mass inside.

For maintenance and/or cleaning it is necessary to disassemble and reassemble the whole system, actions that are proved to be lengthy and does not ensure the correct dimension of the vein between the bars (8).

The new expeller is built with a cylindrical tube (12) with openings in the length of the tube (13) and with cavities (14) made on the same direction.

These openings (13) can vary its length and width (12) in such manner that it fits the purpose of expelling the oil to be extracted.

These cavities (14) can be made in the tube (12) or mounted in a cylinder inserted in the tube (12).

With this built, the new expeller has better economic efficiency due to its cost, including maintenance e repeatability in the quality of the oil expelled.

1-6. (canceled)

7. Oil expeller, mounted with an extrusion machine built with a body provided with the feeder connected to the worm screw, an axle is powered by a gear motor and a portion of an exit of the worm screw is involved by the oil expeller, the main characteristic is that the oil expeller is made in one piece and has openings on the wall on the length of the tube and cavities in the tube.

8. Oil expeller, according to claim 7, characterized by the fact that the cylinder may be made with two or more rings connected with themselves.

9. Oil expeller, according to claim 7, characterized by the fact that these openings have the same length through out the whole length of the tube.

10. Oil expeller, according to claim 7, characterized by the fact that these openings vary the length through out the whole length of the tube.

11. Oil expeller, according to claim 7, characterized by the fact that these openings have the same width through out the whole length of the tube.

12. Oil expeller, according to claim 7, characterized by the fact that these openings have variable width through out the whole length of the tube.
